(19) United States
(12) Patent Application Publication
(10) Pub. No.: US 2025/0269403 A1
(43) Pub. Date: Aug. 28, 2025

(54) MULTI-STAKE UNDERWATER TRANSDUCER AND ARRAY

(71) Applicant: MICROFINE MATERIALS TECHNOLOGIES PTE. LTD., Singapore (SG)

(72) Inventors: Leong Chew LIM, Singapore (SG); Yuexue XIA, Singapore (SG)

(21) Appl. No.: 18/850,705

(22) PCT Filed: Mar. 25, 2022
(86) PCT No.: PCT/SG2022/050165

§ 371 Date: Sep. 25, 2024

(51) Int. Cl. B06B 1/06; H10N 30/853; H10N 30/88

(52) U.S. Cl. CPC B06B 1/0618; H10N 30/8554; H10N 30/88

(57) ABSTRACT

The present invention relates to multi-stake underwater transducers and arrays for the generation and reception of sound waves in water. The invention provides the design and fabrication of compact piston-type underwater transducers of low-to-mid operating frequency made of piezoelectric single crystals without the need of any pre-stress mechanism. The invention uses a multi-stake pipe-like motor section made of piezoelectric single crystals of high transverse mode piezoelectric coefficients and low acoustic impedance, and small-diameter and light head mass(es). The present invention also discloses various means of increasing the bandwidth of the multi-stake underwater transducers as well as derivative transducers and arrays made of them, including compact 2D and 3D omni-directional transducers, planar, conforming and shaped arrays of various designs, high-density arrays and low-drop-down-ratio parametric arrays of either single or dual frequency bands.

### TECHNICAL FIELD

The present invention relates to transducers, and more specifically, to underwater transducers and arrays for the generation and reception of sound waves in water.

### BACKGROUND

A transducer is a device that converts energy from one form to another. Transducers can be used under water as both transmitters and receivers of sound waves. These transducers are commonly referred to as SONAR (Sound Navigation and Ranging). SONAR can be used for ocean surveillance, detecting and identifying objects underwater, depth sounding, bathymetric imaging and underwater communication. Conventional underwater transducers generate and transmit a signal in the form of a pulse of sound. The returning “echo” of the signal is then detected. The time for transmission to reception of the pulse can be used to measure of the distance traveled by the sound wave.

Conventional underwater transducers use piezoelectricity. Piezoelectric transducers convert the electrical signals applied to them into vibrational mechanical energy and vice versa. A common piezoelectric material is lead zirconate titanate (Pb[Zr₁₋ₓTiₓ]O₃ or PZT) which has defined the technology for decades.

Most of the underwater transducers use a PZT ring or plate stacks that are driven in longitudinal (33-) mode. While having a high piezoelectric strain coefficient, 33-mode piezoelectric active elements also have high acoustic impedance compared to water. This causes a substantial portion of sound wave to reflect back at the water-ceramic interface, leading to low power efficiency of the device. To improve the power efficiency for both transmission and reception, various means of acoustic matching have been developed and utilised.

Underwater transducers used for sound generation operating in the frequency range from a few kHz to low hundreds of kHz use a common design of tonpilz (“tonpliz” being a germen word for “singing mushroom”) or piston type. In such a design, a piston having a projecting surface area larger than the active material load bearing area is utilised to reduce the mismatch in acoustic impedance between the piezoceramic and water. FIG. 1 depicts a typical structure of a tonpilz underwater transducer and its key components including the piston (head mass) 12, electrode 14, tail mass 16, stress rod 18, disk springs 20, insulator 22 and PZT rings 24.

There is a large mismatch in acoustic impedance between PZT piezoceramic and water, typically 15× to 25×. Because of this, a large piston area, being 15× to 25× that of piezoceramic load bearing area, is required in a tonpilz design. Despite so, for reasons provided below, the piston area in conventional tonpilz transducers is significantly smaller and typically kept at about λw/2 in diameter, as depicted in FIG. 1, where λ_{w} is the wavelength in water at the central frequency (f_{c}) of the operating frequency band of the transducer. The typical diameter of a piston of a conventional tonpilz transducer thus varies from λw/2=100 mm for f_{c}=7.5 kHz to λw/2=10 mm for f_{c}=75 KHz.

To ensure that the piston will not flex, which could adversely affect acoustic performance, an inverted mushroom head-shaped piston of sufficient thickness is used. As a result, the piston in a tonpilz projector is bulky and heavy. It is commonly referred to as the head mass.

Due to inertia effect, the head mass, as well as the top portion of piezoelectric active material, exerts a dynamic stress onto the piezoelectric active material below and the various adhesive joints contained in it during operation of the transducer. Hence in conventional tonpilz underwater transducers, a heavier head mass is associated with a larger induced dynamic stress.

The materials of conventional underwater transducers also present problems. Piezoceramics are brittle and the adhesive joints can be weak under tension. A pre-stress mechanism consisting of a stress rod, resilience members like coil or disk springs, and lock nuts can be incorporated to apply due compression to the piezoceramic active material and the various adhesive joints. This prevents or limits tensile loading during operation. These pre-stress mechanisms have become a standard design feature in tonpilz transducers (see, for example, FIG. 1). These components add to the design complexity. The added weight also reduces bandwidth.

One reason that the piston size of tonpilz transducer is kept at about λw/2 in diameter (but not larger) is that in array formation, the transducer elements are typically spaced at about or less than λw/2 apart to avoid sizable side lobes in beam forming. As result, the transducer density in conventional arrays is about 1 transducer per λw/2×λw/2 array area typically. Because the piston diameter and height of a tonpilz transducer increase with decreasing central frequency, tonpilz transducers of low to mid-operating frequencies driven by PZT ceramics are less amenable to making compact conforming arrays, let alone high-density shaped arrays for certain desired acoustic performance characteristics.

In recent years, efforts have focused on improving materials that are used in underwater transducers. Lead zinc niobate-lead titanate (Pb[Zn_{1/3}Nb_{2/3}]O₃—PbTiO₃ or PZN-PT), lead magnesium niobate-lead titanate (Pb[Mg_{1/3}Nb_{2/3}]O₃—PbTiO₃ or PMN-PT), lead magnesium niobate-lead zirconate titanate (Pb[Mg_{1/3}Nb_{2/3}]O₃—Pb[Zr₁₋ₓTiₓ]O₃ or PMN-PZT) solid solution piezoelectric single crystals and their doped and/or modified ternary and quaternary derivatives have been investigated extensively. These new piezoelectric materials exhibit superior piezoelectric and electro-mechanical properties to PZT piezoceramics.

Piezoelectric single crystals are anisotropic materials which exhibit different properties when poled and/or activated in different crystal directions. For instance, a [011]—poled single crystal bar exhibits extra-ordinarily large transverse strain when the induced strain is measured along the [100] crystal direction. It has been reported that said transverse piezoelectric strain coefficient (designated as d₃₂ in the literature) is in the range of 1200-3000 pC/N for the various lead-based relaxor-PT solid solution single crystals described above, as opposed to d₃₃≈200-600 pC/N and d₃₁≈150-280 pC/N for commercially available PZT piezoceramics.

U.S. Pat. No. 9,673,374 B2 describes a new type of high linearity axial displacement actuator. This design is depicted in FIG. 2. In this design of a multi-stake actuator, the stakes are identical piezoelectric single crystal active elements of suitable compositions and cuts 31. The single crystal elements are bonded by epoxy with the aid of shaped edge-stiffeners 32 into the desired configurations and onto the shaped end caps and/or washer-stiffeners 34 at both ends. Lead wires are bonded onto the electroded faces of the crystals to complete the device (not shown). The bold lines denote epoxy joints 33. The design takes advantage of the extremely high transverse (d₃₂) piezoelectric strain coefficient of piezoelectric single crystals, by bonding identical rectangular-shape d₃₂-mode piezoelectric single crystals with the aid of edge guides into a multi-sided pipe-like structure, and further bonded with top and bottom end caps and/or washers. The resultant “multi-stake” actuator exhibits large yet linear and nearly-hysteresis-free axial displacement as opposed to the non-linear, hysteretic strain behaviour of conventional stack actuators that are made of 33-mode PZT piezoceramics.

Being of a hollow pipe-like structure, the multi-stake actuators have improved bending and twisting stiffness and strength despite their small crystal load bearing area and volume. This, together with the fact that d₃₂-transverse-mode lead-based relaxor-lead titanate solid solution single crystals have comparatively high elastic compliance and hence low acoustic impedance in the active [100] crystal direction, implies that acoustic matching with water can be achieved with a much smaller diameter and hence a lighter head mass should a single crystal multi-stake actuator be used as the motor section of the underwater transducer.

Despite developments in piezoelectric actuator technology, there is a need for an improved underwater transducer. The present invention includes underwater transducers driven by multi-stake transverse mode single crystal actuators with a small and extremely light head mass such that the pre-stress mechanism is no longer required. Also disclosed are the various means to improve the bandwidth of underwater transducers of such a design and the various types of array formed by them.

### Object of the Invention

An object of the present invention is to provide a compact and light underwater transducer made of piezoelectric single crystals and its basic design consideration, notably those of operating frequency in the range from a few kHz (e.g. 3 kHz) to low hundreds of kHz (e.g. 300 kHz).

An object of the present invention is to provide various means to design and fabricate single crystal underwater transducers of broad bandwidth, notably those of operating central frequency from a few kHz to low hundreds of kHz.

It is also an object of the present invention to provide various means to design and fabricate compact 2D and 3D omni-directional underwater transducers made of piezoelectric single crystals notably those of low-to-mid central frequency and broad bandwidth.

It is a further object of the present invention to provide methods of designing and fabricating acoustically tunable λ_{w}/2-sized transducer elements made of piezoelectric single crystals, particularly those of low-to-mid central frequency and broad bandwidth, λ_{w} being the wavelength in water at the central frequency of the operating frequency band of the underwater transducer.

It is a further object of the present invention to provide methods of designing and fabricating planar, conforming and shaped arrays of underwater transducers made of piezoelectric single crystals, notably those of low-to-mid central frequency and broad bandwidth.

It is a further object of the present invention to provide methods of designing and fabricating high-density transducer arrays that overcome the limitations of conventional tonpilz or piston-type transducers, including planar, conforming and shaped arrays of various designed acoustic beam patterns and performance characteristics.

It is a further object of the present invention to provide methods of designing and fabricating transducer arrays of dual operating frequency bands, including planar, conforming and shaped arrays of various designed acoustic beam patterns and performance characteristics.

It is a further object of the present invention to provide methods of designing and fabricating low drop-down-ratio parametric arrays of either single or dual frequency bands, which are not possible using conventional tonpilz or piston-type transducers.

These and other objects and advantages of the present invention will become apparent from the following descriptions, taken in connection with the accompanying drawings, wherein, by way of illustration and example, at least one embodiment of the present invention is disclosed.

### SUMMARY OF THE INVENTION

In a first aspect, the present disclosure provides a piston-type underwater transducer, comprising: a motor section constructed from multiple units of d₃₂-or d₃₁-transverse mode piezoelectric single crystals in a form of a hollow polygonal pipe or spaced parallelly-oriented plates or bonded plates configuration, and at least one head mass, wherein the head mass is small in dimensions and light in weight, and thereby does not require a pre-stress mechanism.

In one embodiment, a piston-type underwater transducer is described that operates at a central frequency range of 3 kHz to 300 kHz without a pre-stress mechanism. The transducer can include a single crystal motor section, a first head mass, a second head mass, a housing and sound transparent window material. The motor section can be constructed from multiple units of rectangular-shaped [011]-poled d₃₂- or d₃₁-transverse-mode piezoelectric single crystals in a form of a hollow polygonal pipe or spaced parallelly-oriented plates or bonded plates configuration such that it has an overall load bearing area of less than 40 mm². The first head mass and the second head mass each can have diameters less than 0.4 times the wavelength of sound wave at the operating central frequency in a surrounding medium. Each of the first head mass and the second head mass can weigh less than 4 grams. The housing and the sound transparent window material can protect the motor section, the first head mass and the second head masses from the surrounding medium. The first head mass and the second head mass can emit sound waves through the window material into the surrounding medium.

According to an embodiment in conjunction to the first aspect of the present disclosure, the piezoelectric single crystals are lead-based relaxor-PT solid solution single crystals of the following compositions: lead zinc niobate-lead titanate (Pb[Zn_{1/3}Nb_{2/3}]O₃—PbTiO₃ or PZN-PT), lead magnesium niobate-lead titanate (Pb[Mg_{1/3}Nb_{2/3}]O₃—PbTiO₃ s or PMN-PT), lead magnesium niobate-lead zirconate titanate (Pb[Mg_{1/3}Nb_{2/3}]O₃—Pb[Zr₁₋ₓTiₓ]O₃ or PMN-PZT), lead indium niobate-lead magnesium niobate-lead titanate (Pb[In_{1/2}Nb_{1/2}]O₃—Pb[Mg_{1/3}Nb_{2/3}]O₃—PbTiO₃ or PIN-PMN-PT) and lead indium niobate-lead zinc niobate-lead titanate (Pb[In_{1/2}Nb_{1/2}]O₃-Pb[Zn_{1/3}Nb_{2/3}]O₃—PbTiO₃ or PIN-PZN-PT), including their doped and/or compositionally modified derivatives.

According to an embodiment in conjunction to the first aspect of the present disclosure, the head mass is comprised of one or more of aluminium and aluminium alloys, aluminium-beryllium alloys, aluminium-lithium alloys, magnesium and magnesium alloys, titanium and titanium alloys, their metal matrix composites and/or monolithic alloys with micro-hollow-spheres of various types, high specific modulus engineering ceramics including machinable glass ceramics, or fiber-reinforced polymeric matrix composites.

In an embodiment, the transducer operates at a central frequency range of 3 kHz to 300 kHz.

According to an embodiment in conjunction with the first aspect of the present disclosure, a diameter or a projecting surface area of the head mass provides optimum acoustic matching with a surrounding medium.

In an embodiment, a ratio of head mass area to load bearing area of the piezoelectric single crystals is 3-10.

According to an embodiment in conjunction with the first aspect of the present disclosure, the head mass weighs less than 0.5 grams (g).

In an embodiment, the first head mass and the second head mass are of equal or substantially equal dimensions and weight, and the first head mass and the second head mass emit sound waves into a surrounding medium in λ/2 mode.

According to an embodiment in conjunction with the first aspect of the present disclosure, the two head masses have unequal weights. The heavier head mass acts as a tail mass and only the lighter head mass emits sound waves into a surrounding medium in λ/4 mode or approximately so.

According to an embodiment in conjunction with the first aspect of the present disclosure, the motor section comprises vibrating crystals of less than 9 mm in active length for the promotion of end constraint effect for bandwidth improvement.

According to an embodiment in conjunction with the first aspect of the present disclosure, the motor section is of a two-layer or multi-layer multi-stake type.

According to an embodiment in conjunction with the first aspect of the present disclosure, further comprising two head masses, wherein the two head masses are of unequal masses and either one or both head masses emit sound waves simultaneously into a surrounding medium.

According to an embodiment in conjunction with the first aspect of the present disclosure, the transducer includes a means of applying a pull-down force hence compression to the head mass and the crystals below it through the window material.

In a second aspect, the present disclosure provides a two-dimensional omni-directional underwater transducer comprising multiple units of the piston-type multi-stake underwater transducer configured to provide two dimensional omni-directionality of the derivative underwater transducer.

In a third aspect, the present disclosure provides a three-dimensional omni-directional underwater transducer comprising multiple units of the piston-type multi-stake underwater transducer configured to provide three-dimensional omni-directionality of the derivative underwater transducer.

In a fourth aspect, the present disclosure provides a λ_{w}/2-sized underwater transducer comprising multiple units of the piston-type multi-stake underwater transducer, wherein the λ_{w}/2-size transducer element is acoustically-tunable via suitable accompanied electronics.

In a fifth aspect, the present disclosure provides a piston-type multi-stake underwater transducer of λ/2-mode, wherein both head masses emit sound waves with either a plain baffle or a cavity baffle for increased sound pressure level.

In a sixth aspect, the present disclosure provides a planar, conforming, or shaped array of the piston-type multi-stake underwater transducer comprising multiple units of the piston-type underwater transducer of higher array density than possible with conventional underwater transducer arrays.

In a seventh aspect, the present disclosure provides a dual-frequency underwater transducer array comprising multiple units of the piston-type multi-stake underwater transducers.

In an eighth aspect, the present disclosure provides a parametric array comprising multiple units of the piston-type multi-stake underwater transducers, wherein parametric array has a low drop-down-ratio and either a single-frequency-band or a dual-frequency-band.

In a ninth aspect, the present disclosure provides a dual-mode underwater transducer comprising the piston-type multi-stake underwater transducer, wherein the dual-mode underwater transducer generates and receives underwater sound waves.

In a tenth aspect, the present disclosure provides a dual-mode underwater transducer array comprising of the planar, conforming, or shaped array, the dual-frequency underwater transducer array or the parametric array.

In an eleventh aspect, the present disclosure provides a multi-stake underwater transducer, comprising a motor section, a first head mass, a second head mass, wherein the motor section is comprised of multiple d₃₂-or d₃₁-transverse mode piezoelectric single crystals that are configured into a hollow polygonal or pipe shape, wherein the single crystals are joined to a small-diameter and light piston, and wherein the transducer has a piston-to-crystal area ratio of between 4 to 10 without any pre-stress mechanism.

### BRIEF DESCRIPTIONS OF THE DRAWINGS

FIG. 1 depicts a typical prior art tonpilz underwater transducer with a piston (head mass) and a heavy tail mass. Also shown is a pre-stress mechanism to place the piezoceramic active elements and the various adhesive joints contained in it under due compression.

FIG. 2 depicts the design of a multi-stake single crystal actuator according to prior art.

FIG. 3 depicts an embodiment of a λ/2-mode underwater transducer of the present invention.

FIG. 4 is a graph of the transmit voltage response (TVR) of an underwater transducer of the transducer of FIG. 3 in which the multi-stake square-pipe motor

section is made of four identical rectangular-shaped[011]-poled d₃₂-mode PZN-5.5% PT single crystals of 25 mm (L)×4.2 mm (W)×0.4 mm (T) in dimensions and weigh about 1.4 g in total. Both head masses are of about 7 mm in diameter and 2.0 mm in thickness, made of aluminium and weigh about 0.2 g each. The acoustic result was taken with the acoustic axis lying orthogonal to the axis of the transducer and both head masses emit sound waves simultaneously.

FIG. 5 is a graph of the TVR of the same underwater transducer shown in FIG. 4 but with the acoustic axis parallel to the axis of the transducer and with only the facing head mass emitting sound wave by covering up the acoustic window of the opposite head mass with a metal end cap to isolate it from the water medium.

FIG. 6 depicts another embodiment of multi-stake underwater transducer of the present invention. In this example, one of the head masses is much heavier than the other and functions as a virtually non-vibrating tail mass, thus forming a λ/4-mode underwater transducer.

FIG. 7 is a graph of the TVR of a λ/4-mode multi-stake underwater transducer described in FIG. 6 having a motor section of the same square-pipe cross-section as in FIG. 5 but a crystal length of 9 mm.

FIG. 8A, 8B, 8C and 8D depict designs of a multi-stake transducer of the present invention having simplified motor section constructions.

FIG. 9 is a graph of the TVR of another λ/4-mode underwater transducer having a motor section of same square-pipe cross-section as in FIG. 7 but a shorter crystal length of 5 mm.

FIG. 10 depicts a λ/4-mode underwater transducer with a two-layer multi-stake motor section.

FIG. 11 is a graph of the TVR of a λ/4-mode two-layer multi-stake underwater transducer, of same crystal length and comparable overall crystal cross-sectional area to that shown in FIG. 7.

FIG. 12 depicts a λ/2-mode multi-stake underwater transducer of unequal mass design.

FIG. 13A and 13B are graphs of TVRs of a multi-stake underwater transducer of unequal mass design. FIG. 13A shows the TVR when only the lighter head mass is used as the sound emitting face (with the heavier head mass side covered up with a metal end cap) and with the acoustic axis in line with the axis of the transducer, while FIG. 13B shows the TVR when both head masses emit sound waves simultaneously with the acoustic axis lying orthogonal to the axis of the transducer. A baffle was not used in either study.

FIG. 14A, 14B and 14C depict designs of transducers in which a pull-down force, hence compressive stress, is generated onto the head mass and the crystals below via the window material.

FIG. 15A and 15B depict prospective views of a compact 2D omni-directional projector made of two units of λ/2-mode multi-stake underwater transducer shown in FIG. 4 at cross deposition. The derivative transducer measures <40 mm both in diameter and height.

FIG. 16A is a graph of the TVR of the transducer shown in FIG. 15.

FIG. 16B is a graph of the beam pattern of the transducer shown in FIG. 15.

FIG. 17A and 17B depict a compact three-tier 2D omni-directional projector made of three units of λ/2-mode multi-stake underwater transducer shown in FIG. 3 at 60° deposition to one another. The derivative transducer measures <40 mm in diameter and <60 mm in height.

FIG. 18A and 18B depict a 2D omni-directional transducer made of multiple units of multi-stake underwater transducer of the present invention of (a) λ/4-mode and (b) λ/2-mode, respectively. The dash-lines show the regions which can be filled with sound transparent material to give the transducer an overall cylindrical shape for streamlining purposes.

FIG. 19 depicts another example of a 2D omni-directional transducer made of multiple units of multi-stake underwater transducer.

FIG. 20A and 20B depict other examples of a 2D omni-directional transducer made of multiple units of multi-stake underwater transducer. FIG. 20B shows the device encapsulated in a sound transparent material 408 such as polyurethane (PU).

FIG. 21 shows an omni-directional underwater transducer formed by stacking two units of 2D omni-directional underwater transducer depicted in FIG. 17 for increased sound pressure levels.

FIG. 22A and 22B depict other designs of stacked omni-directional underwater transducers.

FIG. 23 depicts another design of a stacked omni-directional underwater transducer.

FIG. 24 depicts a λ_{w}/2-sized transducer element made of seven units of λ/4 mode multi-stake underwater transducer for enhanced acoustic characteristics, λ_{w} being the wavelength in water at the central frequency of the operating frequency band of said λ_{w}/2-size underwater transducer.

FIG. 25 depicts a high-density planar array made of multiple units of single-head-mass λ/4-mode multi-stake underwater transducers.

FIG. 26 is a graph of the TVR of a transducer determined over a much wider frequency range. Also shown are the dimensions of λ_{w}/2 in water at different frequencies and typical head mass diameters of multi-stake transducers of the present invention.

FIG. 27 is a graph of the TVRs of another λ/2-mode multi-stake underwater transducer with the acoustic axis being orthogonal to the axis of the transducer and both head masses emitting sound waves simultaneously under three different baffle conditions: (a) in the absence of any baffle, (b) in the presence of a plain rigid baffle and (c) in the presence of a of a half-circular cavity rigid baffle of R=12 mm which helps to deflect the sound energy toward the acoustic axis direction.

FIG. 28 depicts a slim planar array made of cavity-baffled multi-stake underwater transducers.

FIG. 29A and 29B depict a conforming array made of cavity-baffled multi-stake underwater transducers.

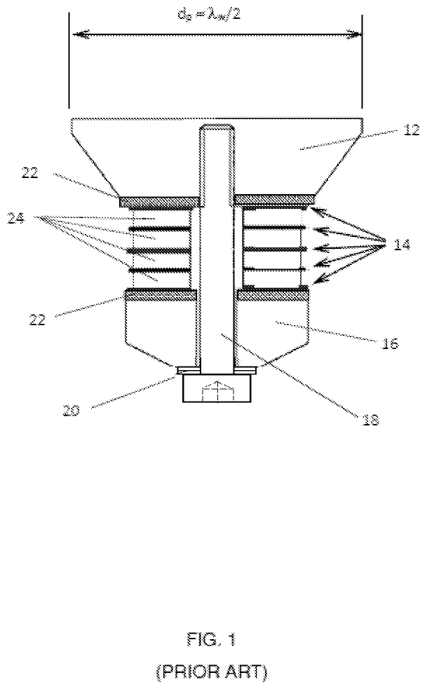

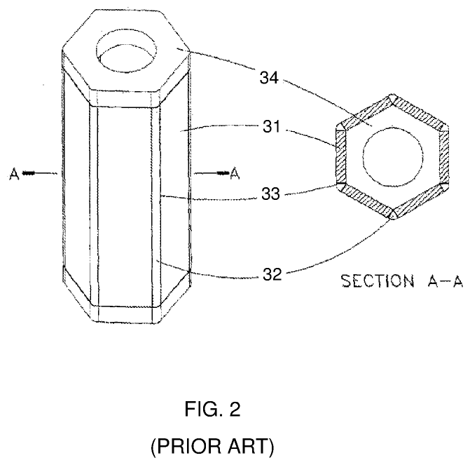

### DETAILED DESCRIPTION OF THE INVENTION

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably. The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

### Multi-Stake Underwater Transducers

Embodiments include underwater transducers, methods of fabrication and use. Particular embodiments include the design and fabrication of compact and light piston-type underwater transducers of low to mid operating central frequency made of piezoelectric single crystals. The transducers can use a multi-stake pipe-like motor section of piezoelectric single crystals of high transverse mode piezoelectric coefficient and low acoustic impedance, and small-diameter and extremely light head mass so that a pre-stress mechanism is not needed. Embodiments also include various means of increasing the bandwidth of multi-stake underwater transducers. Also disclosed are derivative transducers and arrays made of elemental transducers that use the multi-stake design, including acoustically-tunable λ_{w}/2-sized transducer element, compact two-dimensional (2D) and three-dimensional (3D) omni-directional transducers of various designs, high-density planer, conforming and shaped arrays of either single or dual operating frequency band, and low-drop-down-ratio compact parametric arrays of either single or dual frequency bands

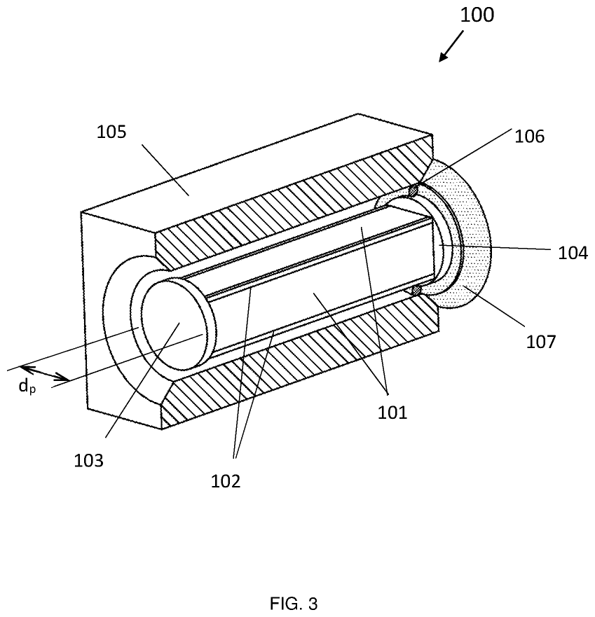

FIG. 3 depicts a design of a λ/2-mode multi-stake underwater transducer 100. The motor section includes four identical rectangular-shaped piezoelectric single crystals 101 bonded with the aid of edge-guides 102 into a square-pipe structure. Each end of the multi-stake motor section is bonded with a head mass. In this example, the two head masses 103, 104, are almost identical in design and weight except that one of them contains a wire groove for inner electrode wiring purposes (neither the groove nor wiring are shown in this figure for clarity). The assembly is inserted into the cylindrical cavity of a metal housing 105 with the aid of centering-cum-cushioning O-rings 106 and both open ends of the housing cavity are further sealed with sound transparent material 107 for waterproofing purposes. Upon activation with an alternating current voltage signal, the crystals will vibrate in resonance in λ/2 mode causing both head masses to vibrate accordingly and emit sound wave through the acoustic windows into the adjacent water medium. Conventional underwater transducer of tonpilz design requires a pre-stress mechanism. For reasons described below, no pre-stress mechanism is required for underwater transducers of the prevent invention.

As noted, the motor section includes four piezoelectric single crystals in a multi-stake square-pipe configuration. Both head masses are of reduced diameter and thickness, hence light in weight.

In a preferred embodiment, the rectangular-shaped piezoelectric single crystals are poled in a [011] crystal thickness direction and its active direction is along the orthogonal [100] crystal direction. The above-described crystal cut is referred to 32- (or d₃₂-) mode crystal by scientists and researchers in the literature, where “d” is a symbol for piezoelectric strain coefficient, the first numeral “3” is conventionally used to indicate the poling direction, which can be any crystal direction although [011] crystal direction is used here, and the second numeral “2” defines that the active direction of the crystal is different from the poling (3-) direction and is the orthogonal [100] crystal direction. The second subscript is changed to “1” if the active direction is the other orthogonal [0-11] crystal direction and the crystal cut is designated as 31- (or d₃₁-) mode crystal. Both [011]-poled d₃₂- and d₃₁-mode crystals are transverse mode crystals as the applied field direction and the active direction are orthogonal to one another, as opposed to longitudinal (33 or d₃₃) mode crystals in which the applied field and active directions are the same.

In a preferred embodiment, the rectangular-shaped piezoelectric single crystals are lead-based relaxor-PT solid solution single crystals of the following material systems, that is, lead zinc niobate-lead titanate (Pb[Zn_{1/3}Nb_{2/3}]O₃—-PbTiO₃ or PZN-PT), lead magnesium niobate-lead titanate (Pb[Mg_{1/3}Nb_{2/3}]O₃—PbTiO₃ or PMN-PT), lead magnesium niobate-lead zirconate titanate (Pb[Mg_{1/3}Nb_{2/3}]O₃—Pb[Zr₁₋ₓTiₓ]O₃ or PMN-PZT), lead indium niobate-lead magnesium niobate-lead titanate (Pb[In_{1/2}Nb_{1/2}]O₃—Pb[Mg_{1/3}Nb_{2/3}]O₃—PbTiO₃ or PIN-PMN-PT) and lead indium niobate-lead zinc niobate-lead titanate (Pb[In_{1/2}Nb_{1/2}]O₃—Pb[Zn_{1/3}Nb_{2/3}]O₃-PbTiO₃ or PIN-PZN-PT) solid solution crystals, including their doped and/or compositionally modified derivatives.

[011] -poled single crystals of the above-said compositions exhibit extremely high d₃₂-mode transverse mode piezoelectric strain coefficients. For instance, [011]-poled PZN-5.5% PT single crystal displays d₃₂ value of around 2200 pC/N, as opposed to d₃₁<300 pC/N for PZT piezoceramics. [011]-poled single crystals of the above-said compositions also exhibit high d₃₂-values, typically in the range of 1200-2600 pC/N.

In addition, [011]-poled d₃₂ mode single crystals of the above-described compositions possess sufficiently high coercive field strength and reasonable transformation properties including transformation temperature, electric field, and axial stress, rendering them candidate active materials for underwater transducers.

For [011]-thickness-poled d₃₂-mode single crystals of the above-described lead-based relaxor-PT solid solutions, their elastic compliance and hence the sound velocity along the active [011] crystal direction is much lower than that of PZT

piezoceramics. This leads to their low acoustic impedance when [011]-poled d₃₂-mode crystals are used to fabricate underwater transducer.

For example, for [011]-poled d₃₂-mode PZN-5.5% PT single crystal, the acoustic impedance along the active [100] crystal direction is in the range from 7 to 8.5 MRayls, as opposed to 22-38 MRayls for conventional PZT piezoceramics. As a result, optimum acoustic matching with water, the latter having an acoustic impedance of 1.5 MRayls, can be readily achieved with a piston-to-crystal area ratio of around 4 to 8. Other lead-based relaxor-PT single crystals described above have higher acoustic impedance but still much lower than the acoustic impedance of PZT-based piezoceramics. As a result, a piston-to-crystal area ratio of ≤10 suffices for optimum acoustic impedance matching with water when [011]-poled d₃₂-mode crystals are used as the motor section of underwater transducers.

Because the multi-stake actuator has a hollow pipe-like structure, the overall crystal load bearing area is many times smaller than that of conventional tonpilz transducers driven by d₃₃-mode PZT ring stack. This, together with the required low piston-to-crystal area ratio for good acoustic impedance matching described above, implies that a small piston or head mass diameter and hence area suffices for multi-stake underwater transducer of the present invention.

Because the flexural modulus of the head mass is inversely proportional to the square of its diameter, for the same head mass rigidity, that is, that of the same fundamental dome mode frequency, a much thinner head mass suffices in the present invention. As a result, much lighter head masses can be used for the underwater transducers of the present invention.

In a preferred embodiment, the individual head mass is made of high-modulus light-weight materials including but not limited to light metals and alloys such as aluminium and aluminium alloys, aluminium-beryllium alloys, aluminium-lithium alloys, magnesium and magnesium alloys, titanium and titanium alloys, metal matrix composites of these alloys including their composites and/or monolithic alloys with micro-hollow-spheres of various types, high specific modulus engineering ceramics like machinable glass ceramics, alumina, aluminium nitride, boron carbide, silicon nitride, silicon carbide, and fiber-reinforced polymeric matrix composites.

For example, for a square-pipe multi-stake made of four identical [011]-poled d₃₂-mode PZN-5.5% PT single crystals, each of about 4 mm (W)×0.42 mm (T) in cross-section, a head mass of about 7 mm in diameter (dₚ in FIG. 3) provides near optimum acoustic matching with a surrounding medium, for example water. When the head mass is made of aluminium and of 1.0-1.5 mm in thickness, it weighs <0.2 g and has a high fundamental dome mode resonance frequency >100 KHz.

The extremely small diameter (dₚ) and light head mass, being <10 mm in diameter and <0.5 g in weight typically, is a unique feature of the present invention. Because there are only two transverse adhesive joints (each beneath a head mass) the dynamic tensile stresses produced by the vibrating head masses onto the piezoelectric crystals and adhesive joints are significantly reduced. For this reason, pre-stress mechanisms are not needed in the multi-stake underwater transducer of the present invention. This reduces the complexity in the structure of the device and results in a more compact and light weight device. In contrast, pre-stress mechanisms are essential for conventional tonpilz transduces to ensure their safe operation. As a result, they are more complex, bulkier and much heavier.

The effective head mass of multiple-stake underwater transducer of the present invention, which is comprised of the head mass and a portion of the mass of vibrating crystals and is <5 g typically, is thus much smaller than that of conventional tonpilz transducer. With good acoustic matching and an extremely light head mass, the underwater transducer of the present invention can display broader bandwidths than conventional tonpilz transducer. For the case when the crystals are sufficiently long such that they can vibrate relatively freely with minimum end constraint effects, the expected bandwidth typically lies in between 25%-40% relative to the central frequency of the transducer.

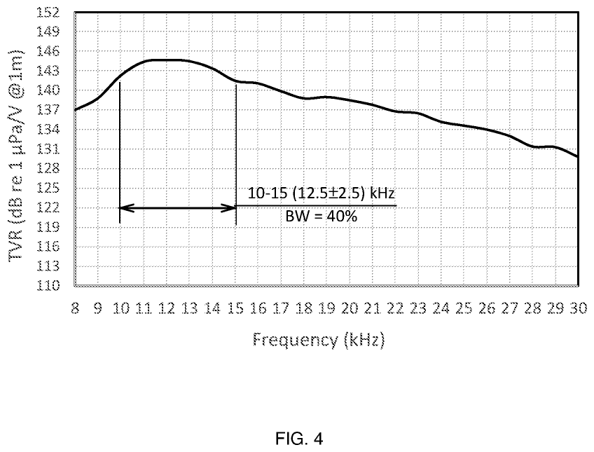

The transmit voltage response (TVR) of an underwater transducer gives the sound pressure level generated at one meter away when an alternating current (a.c.) voltage of 1 Vrms is applied to its motor section. The TVR of the λ/2-mode multi-stake underwater transducer depicted in FIG. 3, having a square-pipe motor section made of four [011]-poled d₃₂-mode PZN-5.5% PT single crystals of 25 mm (L)×4.2 mm (W)×0.4 mm (T) in dimensions and two identical aluminium head mass of about 0.2 g each, is provided in FIG. 4. In this figure, the acoustic axis is orthogonal to the axis of the multi-stake transducer. Both head masses emit sound wave simultaneously into the water medium in the absence of any baffle. Despite its compact size, it has a relatively low central frequency of around 12-13 kHz, a relative bandwidth of 40% and a reasonably high TVR of 144.5 dB (re 1 μPa/V at 1 m).

With a thickness of 0.4-0.5 mm, the crystals of the transducer can be driven to 35 to 45 Vrms before crystal depolarization likely sets in. This gives a sound pressure level of in the range from 175 to 178 dB (re 1 μPa at 1 m) despite its compact size.

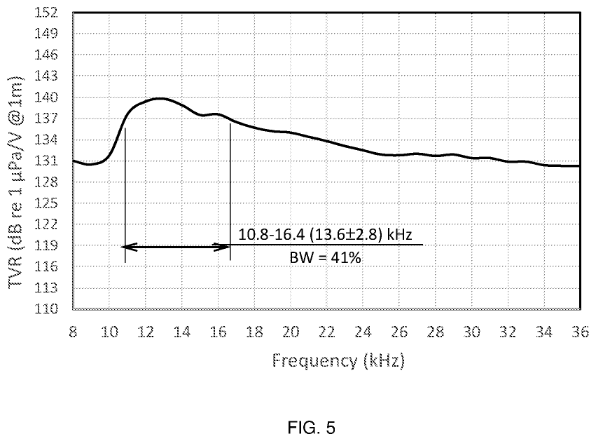

FIG. 5 shows the TVR of the same multi-stake underwater transducer but with the acoustic axis in line with the axis of the transducer. Here, only the facing head mass is emitting sound waves into water. The opposite head mass is shielded with cushion materials and further covered up by means of a metal end cap to isolate it from the water medium. It has comparable frequency response to that shown in FIG. 4 but a reduced TVR level because only one of its two head masses is used to produce underwater sound in this case.

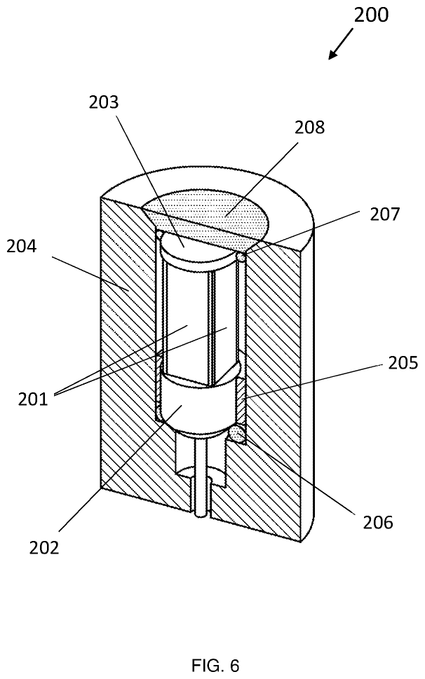

Another embodiment of the multi-stake underwater transducer 200 of the present invention is depicted in FIG. 6. In this example, the motor section is of a similar square-pipe multi-stake construction with four piezoelectric single crystals 201. One of the head masses 202 is much heavier and functions as a virtually non-vibrating tail mass, transforming the device into a λ/4-mode sound emitter. The sound projecting head mass 203 is light in weight, being <0.5 g typically and no pre-stress mechanism is used. Here, the housing 204 has only one opening. The transducer is centered inside the housing via high-damping cushion material 205 and an O-ring 206 at the tail mass side and another O-ring 207 at the head mass side. The head mass is further waterproofed with a sound transparent material 208 to enable it to transmit sound wave into the adjacent water medium.

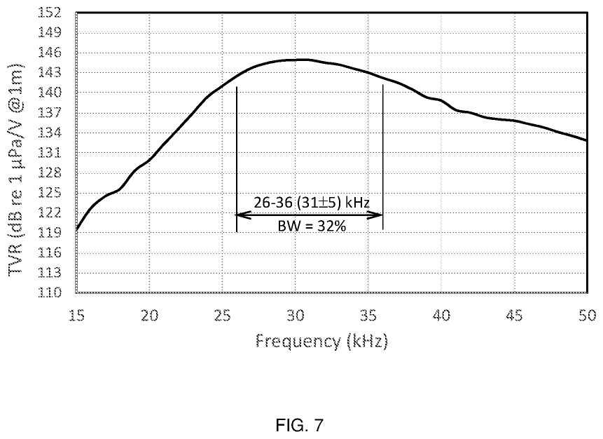

FIG. 7 is a graph of the TVR of a fabricated λ/4-mode multi-stake underwater transducer depicted in FIG. 6. Its motor section has the same square-pipe cross-section as that described in FIG. 4 but a shorter crystal length of 9 mm. Again, despite its compact size, it has a relatively low central frequency of around 30 kHz, a relative bandwidth of 35% and a reasonably high TVR of about 145 dB (re 1 μPa/V at 1 m).

For the same crystal thickness, square-pipe or polygonal-pipe construction of single crystal plates bonded firmly with edge-guides-cum-stiffeners give the best bending and twisting strength for long crystals. Despite so, transducers made of crystals of similar arrangement but without edge guides have also been shown to work well. However, their bending and twisting strengths can be compromised, particularly with longer crystals. Care should be exercised in handling them during fabrication and use.

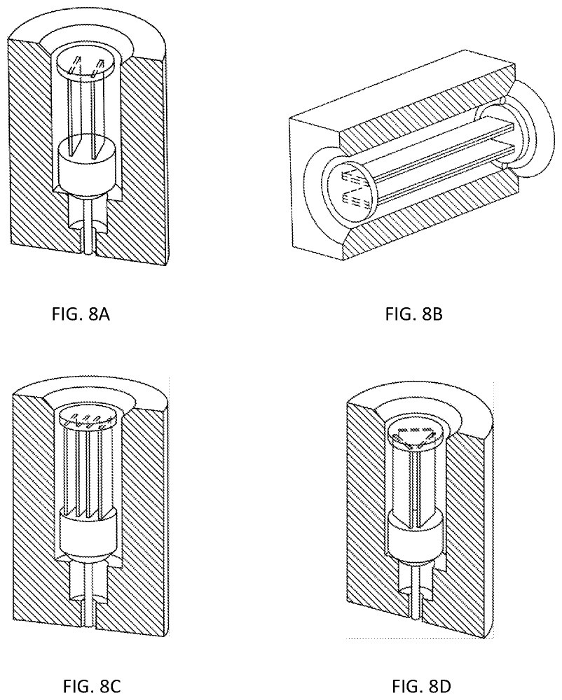

Other designs of the motor section are possible and function equally well, provided that they have sufficient bending and twisting strength for handling during fabrication and/or use. FIG. 8A-8D depict designs of motor sections with relatively simple constructions. Each includes adequately spaced or equally spaced parallelly-oriented crystals or bonded crystal assemblies, circumferentially arranged single crystals into any polygonal form, like triangular, square, hexagonal and so on, either with or without edge guides.

Depending on the actual design central frequency, TVR and sound pressure

level, with the motor section made of [011]-poled d₃₂-mode piezoelectric single crystals, the overall load bearing area of the crystals typically may vary from a few square millimeters (mm²) to 30 mm² for the multi-stake underwater transducers of the present invention. The corresponding head mass typically varies from a few millimeters (mm) to 12 mm in diameter and from <0.2 gram (g) to 1 g in weight. Larger crystal load bearing areas and piston diameters may be possible for transducers of low central frequency, say of a few kHz, and/or of higher TVR and sound pressure level.

### Broadband Multi-Stake Underwater Transducers

Despite being thin and light, the head masses of transducers of the present invention have small diameters and hence high flexural mode resonance frequencies. Because of this, they behave like rigid head mass during operation. As described above, with optimal piston-to-crystal area ratio for acoustic impedance matching with water, the bandwidth attainable by the multi-stake transducer of the present invention typically lies between 25-40% when sufficiently long single crystals are used.

The invention also includes various methods by which the bandwidth of multi-stake underwater transducers may be further broadened.

One method to increase the bandwidth of multi-stake underwater transducer of the present invention is to reduce the thickness and hence the weight of the head mass further, provided that there is no adverse head mass flapping effect. Magnesium-based head masses, aluminium-beryllium and aluminium-lithium head masses, light metal and/or polymer matrix composite head masses, and high-specific modulus ceramic head masses are good for such applications.

Another method is to introduce appropriate mechanical constraint effect to the otherwise free vibration of the crystals. One such constraint is that imposed by the head and/or tail mass. Said end constraint effect is also present in the example transducers of which the TVRs are shown in FIGS. 4, 5 and 7. However, the affected length portion of the crystals is not significant due to the long crystals used in these examples.

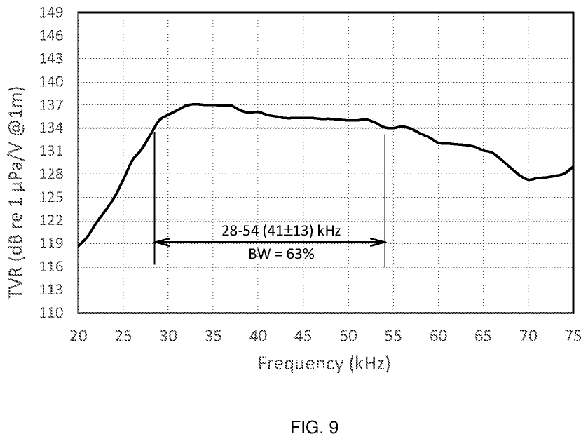

FIG. 9 is a graph of the TVR of another fabricated λ/4-mode multi-stake underwater transducer having a motor section of the same cross-section as that described in FIG. 7 but of 5 mm in crystal length. With proper design, this transducer displays a significantly broader bandwidth of >60%. This may be attributed to the end constraint effect imposed by both the head mass and the tail mass onto the short vibrating crystals, which is effective for short crystals. This applies to multi-stake underwater transducers of higher operating frequency band, e.g., those with a central frequency of ≥30 KHz.

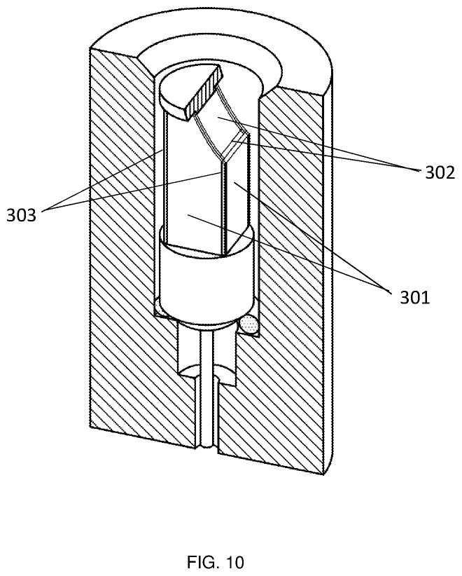

Yet another effective way of improving the bandwidth of a multi-stake underwater transducer is to introduce lateral mechanical constraint to the vibrating crystals via a multi-layer stake structure. FIG. 10 depicts an example in which the motor section includes eight piezoelectric single crystals 301 and 302 bonded with the aid of edge-guides 303 into a two-layer square-pipe multi-stake structure.

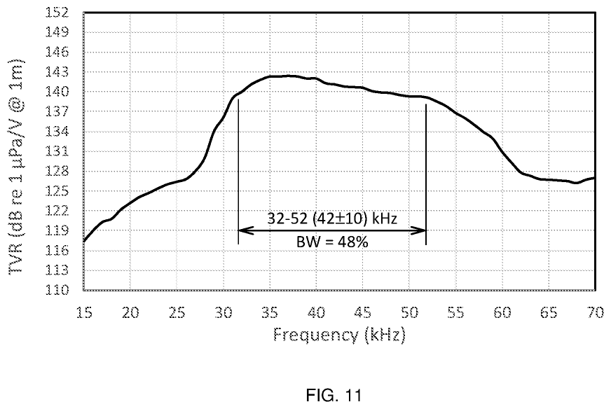

FIG. 11 is a graph of the TVR of a λ/4-mode two-layer multi-stake underwater transducer, of same crystal length and comparable overall crystal cross-sectional area to that described in FIG. 7. It should be noted that in this case the bandwidth is improved despite the small difference of 0.5 mm in width between the inner and outer layers of crystal (of 4.2 mm and 4.7 mm width respectively).

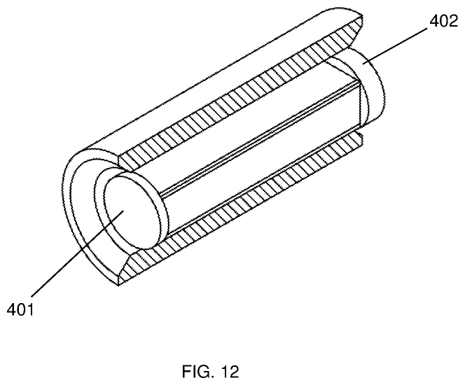

FIG. 12 depicts another embodiment of the multi-stake underwater projector of the present invention. In this example, the two head masses are of different weights. More specifically, while one of the head masses 401 is kept light as described earlier (e.g. <0.3 g), the opposite head mass 402 is made slightly heavier (e.g. <1 g). No pre-stress mechanism is needed. In such a design, either one or both head masses can be used to transmit sound into water. With adequate design, multi-stake underwater transducers of said unequal mass design also display TVR of improved bandwidth.

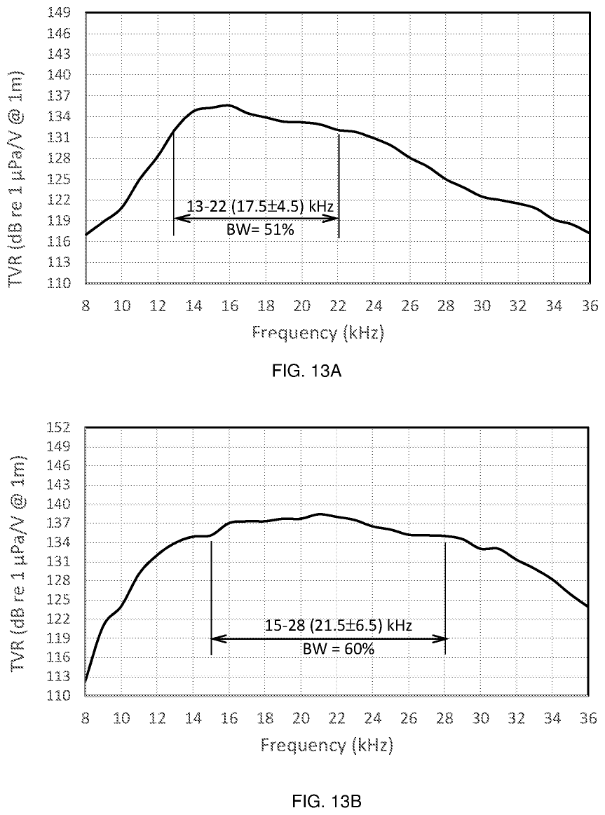

FIG. 13A and 13B show the TVR of a multi-stake underwater transducer of the present invention of unequal mass design described in FIG. 12. In FIG. 13A, only the lighter head mass is used as the projecting face (with the heavier head mass side covered up with a metal end cap) and with the acoustic axis in line with the axis of the transducer. FIG. 13B shows the case when both head masses emit sound waves simultaneously with the acoustic axis being orthogonal to the axis of the transducer. No baffle was used in either case.

Imposed lateral constraint design and unequal mass design for bandwidth improvement are more suitable for multi-stake underwater transducers in which long crystal active length is needed, such as those of lower central operating frequency. Despite so, they are also effective means of bandwidth improvement for transducers of short crystal active length and hence higher central operating frequency.

The various broadband designs of multi-stake underwater transducer described above, that is, extremely light head mass, imposed end constraint effect (of short active material), imposed lateral constraint effect (of multi-layer multi-stake design) and unequal mass design, as well as their combinations, are hereafter collectively referred to as “broadband multi-stake designs.” And, the resultant transducers are hereafter referred to as “single-head-mass” or “λ/4-mode multi-stake” underwater transducers when only one head mass is used to emit sound into the water medium.

When used under water, the water pressure will apply a compressive force onto the head mass and hence the crystals in the motor section of the transducer of the present invention. The induced compressive stress, which is amplified by the piston-to-crystal area ratio, places the single crystals and the adhesive joint between the head mass and the crystals in compression which is advantageous to the operation of the transducer of the present invention.

When the head mass and the head-mass-end of the crystals are moving in perfect synchronization, there is minimum dynamic stresses induced by the head mass onto the crystals. The actual dynamic stress generated is thus that arising from relative displacement between the head mass and the top end face of the crystals during operation of the transducer.

The above-said relative displacement during operation of the transducer is typically a fraction of that when only the crystals are vibrating and the head mass is stationary instead. Taking this fraction to be 20% and into account the area ratio loading effect between the head mass and the crystals, calculations show that with an extremely light head mass (for example, about 0.2 g), the dynamic stress generated by the head mass is quite small and that 5 meter water depth is sufficient to generate due compressive stress to ensure safe operation of the transducer.

For example, a fabricated multi-stake transducer of λ/4 mode of the present invention was driven in 0.9 meter water depth at the designed sound pressure level of 176 dB (re 1 μPa at 1 m), at 10% duty cycle for up to 1 hour. Immediately after said endurance test, the TVR of the transducer was measured at a lower applied alternating current (AC) voltage. The result revealed that there was no degradation in TVR indicating that the multi-stake transducer works fine even in very shallow water.

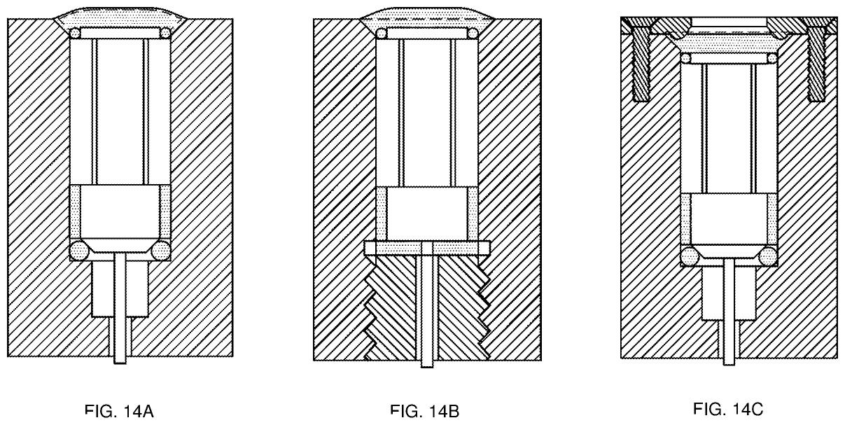

Although not mandatory, when so desired, one may apply a light but beneficial compressive force to the head mass and the crystals below through the sound transparent window material via suitable mechanical means. Examples of such are provided in FIG. 14A-14C.

FIG. 14A illustrates a design with a polyurethane (PU) window material molded into such a geometry that as it shrinks upon setting, it exerts a pull-down force onto the head mass and the crystals below. FIG. 14B shows a design in which the housing has a base that can be adjusted upward to push the transducer up against the molded PU window material to enable the latter to exert a pull-down force onto the head mass and the crystals below. In FIG. 14C, a detachable window end cap with downward protrusions is used which would exert a downward force on the circumferential region the PU window material and hence the head mass upon assembly. The dash-lines in these figures show the profiles of PU window material in a stress-free state (FIG. 14A), prior to the insertion of the base of the housing (FIG. 14B) and to the application of the top window end-cap (FIG. 14C).

### Compact Omni-Directional Underwater Transducers

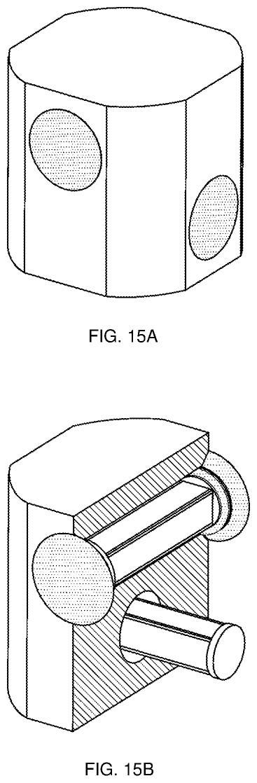

FIG. 15A depicts another embodiment of the present invention. In this example, a compact two-dimensional (2D) omni-directional transducer is realised by placing two units of λ/2-mode multi-stake underwater transducer in cross disposition, as shown in the longitudinal section in FIG. 15B. The derivative 2D omni-directional transducer remains compact in size measuring <40 mm in diameter and height.

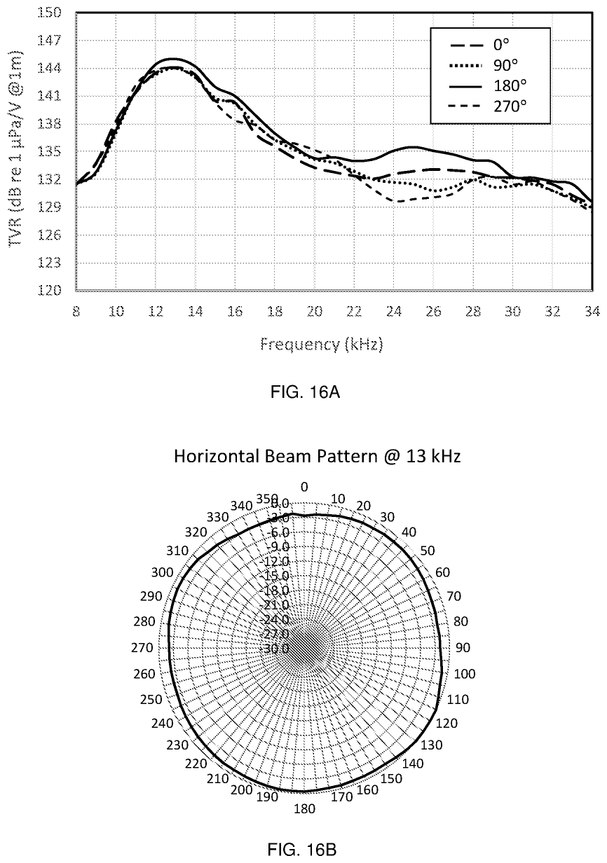

FIG. 16A shows the TVR of the transducer of FIG. 15. FIG. 16B shows the horizontal beam pattern in the azimuth plane of the transducer.

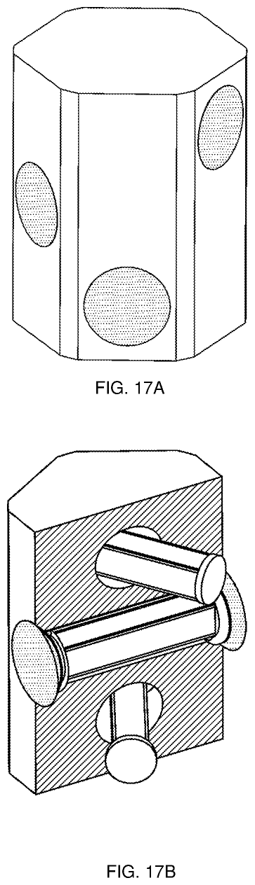

FIG. 17 depicts another embodiment of a three-tier compact 2D omni-directional transducer that includes three units of λ/2-mode multi-stake underwater transducer of identical design to that of FIG. 15 but disposed at 60° apart. In this example, the derivative transducer measures <40 mm in diameter and <60 mm in height.

The three-tier omni-directional transducer depicted in FIG. 17A and 17B can be fitted with λ/2-mode multi-stake underwater transducers of unequal head masses as shown in FIG. 12 for improved bandwidth.

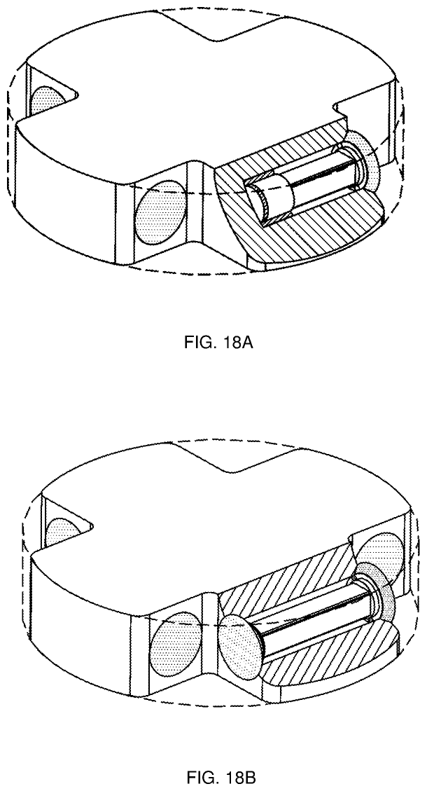

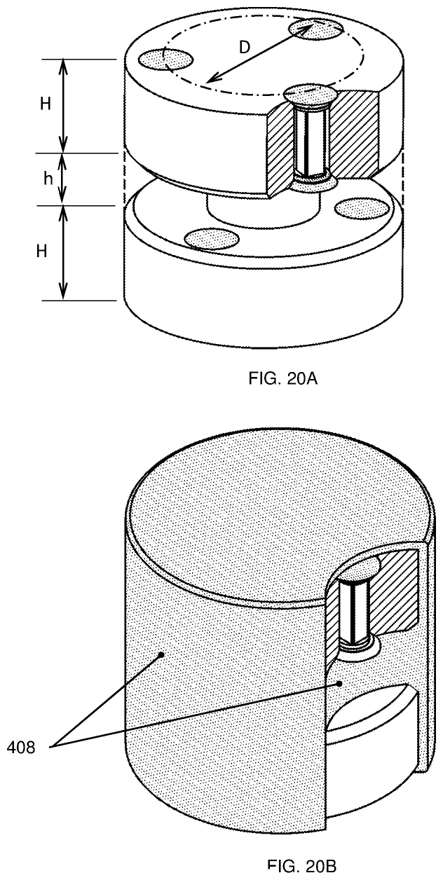

FIGS. 18A, 18B, 19, 20A and 20B depict other configurations of compact 2D omni-directional transducers made of multiple units of multi-stake underwater transducers of the present invention. The dash-lines show the regions which may be filled with sound transparent material to give the transducer an overall cylindrical shape for streamlining purposes. FIG. 20B depicts the device that is encapsulated in a sound transparent material 408, such as polyurethane (PU).

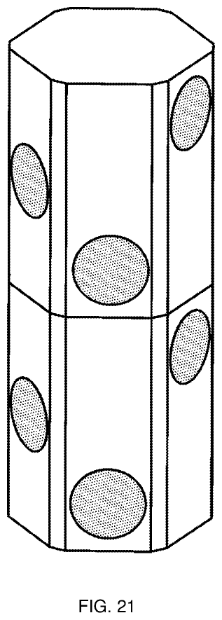

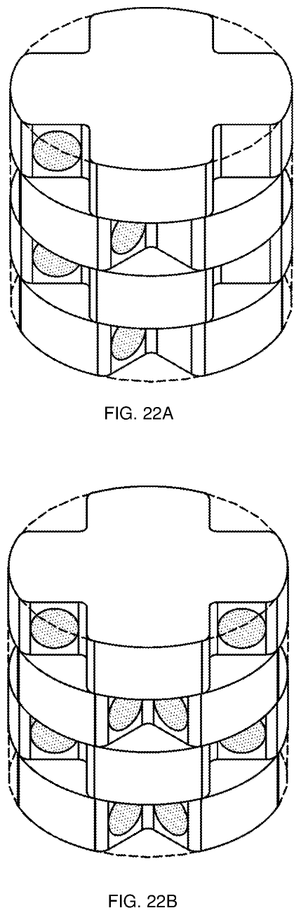

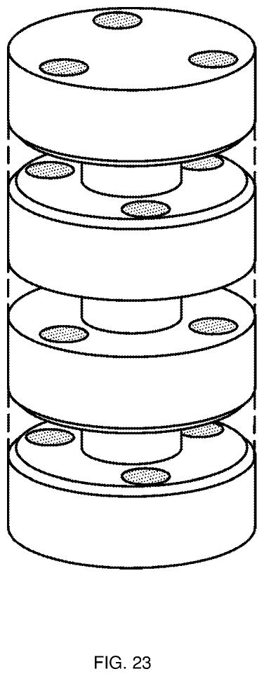

FIGS. 21, 22A, 22B and 23 show that multiple units of omni-directional transducers (as depicted in FIGS. 15, 17, 18, 19 and 20) can be stacked along their axis to make omni-direction transducer of increased sound pressure level. The dash-lines in FIG. 22A, 22B and 23 show the regions which can be filled with sound transparent material to give the resultant transducer an overall cylindrical shape for streamlining purposes. The stacked transducers have a toroidal beam pattern in the vertical plane, of which the beam width decreases with the number of stacks in the device.

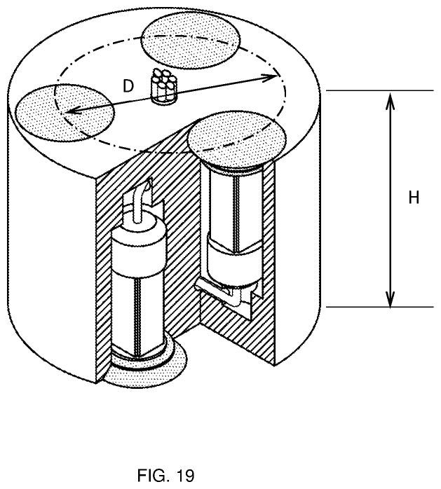

By engineering the pitch-center-diameter-to-height ratio (example D/H ratio in FIGS. 19 and 20A) of the transducers, the number of component multi-stake transducer, relative head mass position in respective tiers (example, h-value in FIG. 20A), and taking advantage of possible baffle effects provided by the housing frame structure, 3D omni-directional transducers of different designs can also be realised using the housing designs shown in FIGS. 19 and 20A as well as by other suitable housing designs.

### Acoustically-Tunable λ_{w}/2-Sized Transducer Element

As explained earlier, for improved acoustic impedance matching, conventional tonpilz-type underwater transducers made of PZT piezoceramics are of much larger head mass diameter, being about or slightly smaller than λ_{w}/2 of the operating central frequency in water. In other words, each piezoceramic transducer of tonpliz design itself is a “λ_{w}/2-sized element”. One reason for keeping the piston diameter at around λ_{w}/2 in size but not larger (for further improvement in acoustic impedance matching) is to facilitate the fabrication of transducer array of desired acoustic performance with controlled side lobe strength.

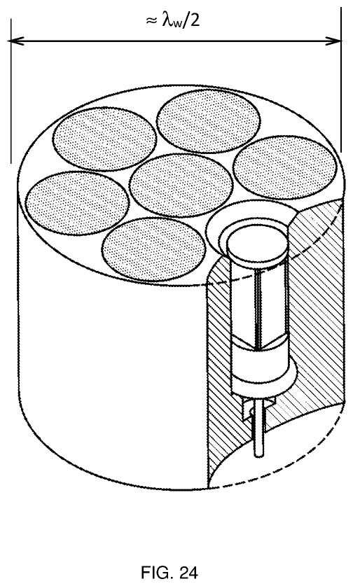

Because the head mass diameter of multi-stake underwater transducer of the present invention is many times smaller than λ_{w}/2 of the operating central frequency, it is possible to pack multiple units of multi-stake transducer into a λ_{w}/2×2_{w}/2 space to form an individual λ_{w}/2-sized element. FIG. 24 depicts an example of such a design. Here, the λ_{w}/2-sized element includes seven units of single-head-mass λ/4-mode multi-stake underwater transducer, giving effectively 7× or 19 dB higher sound pressure level than individual multi-stake underwater transducer.

More interestingly, unlike conventional λ_{w}/2-sized element, with suitable driving electronics, the above-described λ_{w}/2-sized element of the present invention is acoustically-tunable in terms of its TVR response, beam pattern and beam steerability. A similar approach can be used to fabricate underwater transducer elements smaller than λ_{w}/2 in lateral dimension when so desired.

### High-Density Underwater Transducer Arrays

Underwater transducers of tonpilz design are often used in the form of array of regular arrangement. This not only increases the overall sound pressure level of the resultant device but also enables one to modify the beam pattern and steer the acoustic beam when fitted with accompanied electronics. In addition, a multi-beam scanning device can be realised when the array size is sufficiently large.

In forming arrays, the transducer elements are typically spaced not more than λ_{w}/2 apart, λ_{w} being the wavelength in water at the central operating frequency of the array. This is because side lobes of sufficiently high strength may result when the transducer elements are spaced larger than λ_{w}/2 apart. High side lobe strength introduces strong but unwanted echoed signals and hence is highly undesirable. Because conventional tonpilz elements are typically of about λ_{w}/2 in piston diameter, conventional arrays have a relatively low density of one transducer per λ_{w}/2×λ_{w}/2 array projecting area.

In contrast, because the head mass of multi-stake transducer of the present invention are much smaller in size, this enables arrays of significantly higher array density that are not possible with conventional tonpilz elements.

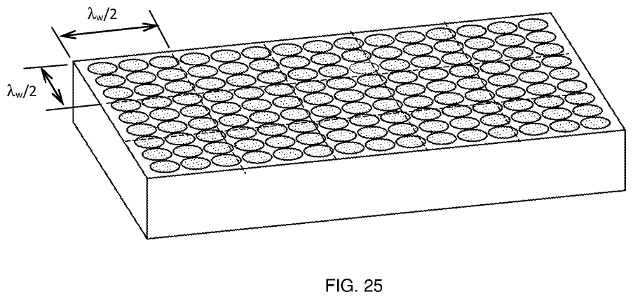

FIG. 25 illustrates an example of a high-density planar array so formed. Such a high-density transducer array can be a planar array, conforming array, or shaped array for various desired acoustic beam patterns and performance characteristics, including beams of designed half-conical angle, focused beam, e.t.c.

The acoustic characteristics of the high-density transducer arrays described above can be modified or tunned with appropriate electronics and drive signals, either per multi-stake transducer or per group of transducers. Such high-density arrays are also highly suitable as a multi-scanning-beams source.

### Dual-Frequency Underwater Transducers and Arrays

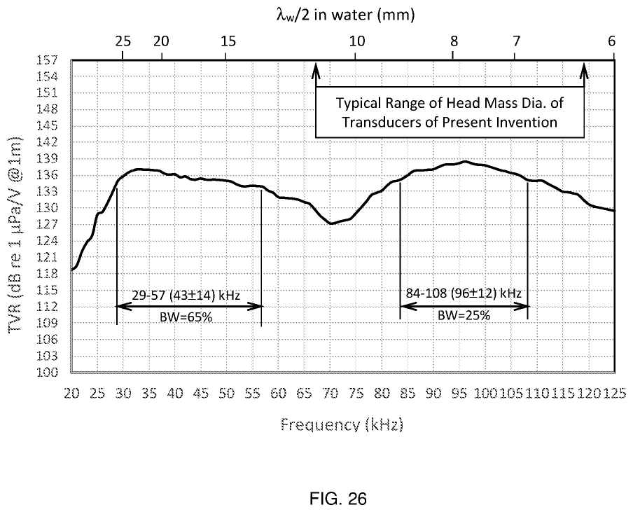

FIG. 26 shows the TVRs of a transducer of the present invention determined over a much wider frequency range. In addition to the fundamental TVR peak described earlier, comparable TVR peak and bandwidth is also evident for the next higher resonance mode. In other words, individual multi-stake transducers of the present invention are also suitable for use as a dual or multiple frequency source of broad bandwidth.

Also indicated in FIG. 26 are the λ_{w}/2 dimensions in water at different frequencies and typical head mass dimensions of multi-stake transducers of the present invention. It is interesting to note that their head mass dimensions are comparable or smaller than the λ_{w}/2 dimension of the central frequency of the higher resonance mode. In other words, the transducers of the present invention are suitable for making dual-frequency arrays of controlled side lobe strengths at both the fundamental and next higher operating frequency bands.

The above-said dual-frequency transducer array may be a planar array, a conforming array, or a shaped array for desired acoustic beam patterns and performance characteristics.

### Low Drop-Down-Ratio Parametric Array of Improved Energy Conversion Efficiency

In a parametric array, two high sound pressure primary sources emit sound waves of slightly different frequencies. They can interact intensely resulting in two secondary waves, one having the sum frequency and the other the difference frequency of the two primary sources. While the higher frequency secondary wave is absorbed quickly by the medium, the lower frequency secondary wave will continue to travel far into the medium. In this case, the lower difference frequency beam is of fine beam width of a few degrees acting more like a parallel, non-spreading sound source.

Parametric arrays as described above typically have low energy conversion efficiency, that is, the sound pressure level of the resultant difference frequency secondary beam is only a few percents that of individual primary sources. In general, the higher the drop-down-ratio (DDR), that is, the ratio of primary-source-frequency to the desired secondary beam frequency, the lower the energy conversion efficiency. A DDR of 10 to 20 is common in conventional parametric arrays, for which the energy conversion efficiency is typically 2-4%.

Due to their compact nature, the multi-stake underwater transducers of the present invention can be used as the primary sources of parametric arrays. Because they are of low to medium central frequencies, a parametric array of low drop-down-ratio (of <10) and hence of improved energy conversion efficiency can be realised. For such applications, high elemental source level instead of broadband multi-stake transducers of the present invention may be used instead for reduced array size.

More interestingly, due to their small head mass, the multi-stake transducers of the present invention can also be used to make compact parametric arrays of dual-frequency-bands. Such a compact dual-band parametric array of improved energy efficiency remains to be realised as of to-date.

The acoustic characteristics of the above-described parametric arrays can be further modified, tunned and shaped with appropriate driving electronics to obtain the desired acoustic performance as well as to form a multi-scanning-beams parametric source.

### High-density Arrays Made of λ/2-Mode Multi-Stake Underwater Transducers

It is of interest to explore if horizontally-oriented λ/2-mode multi-stake underwater transducers of the present invention, of which typical TVR responses are provided in FIG. 4 and FIG. 13B, can be used to form slim transducer arrays and if various baffles can be used to improve the acoustic performance of such arrays.

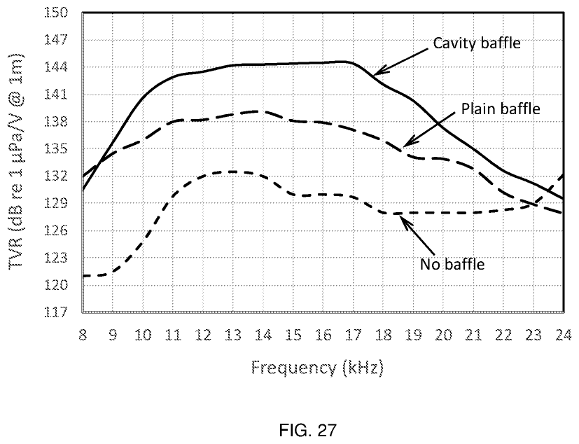

FIG. 27 shows the TVRs of a λ/2-mode multi-stake underwater transducer, of similar construction and test arrangement to that described in FIG. 4 but of three different baffle conditions, that is, (a) in the absence of any baffle, (b) in the presence of a plain rigid baffle and (c) in the presence of a half-circular rigid cavity baffle. As noted, baffles can be used to promote sound energy in the acoustic axis of the transducer. For the cavity-baffle case, the cavity has a radius of 12 mm, which may be filled with sound transparent material. This figure shows that the presence of either a plain or cavity baffle is effective in improving the TVR, notably the cavity baffle case.

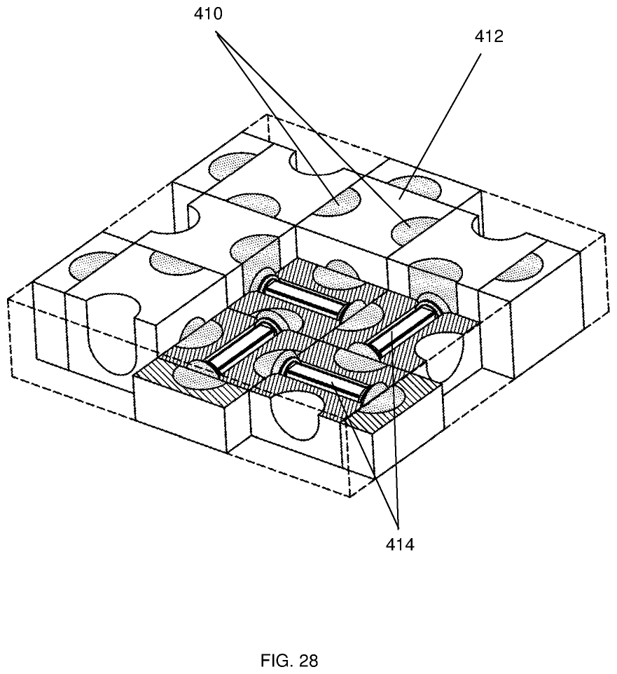

FIG. 28 depicts another embodiment of the present invention showing an example of a slim planar array of <30 mm in thickness made of multiple units of cavity-baffled λ/2-mode multi-stake underwater transducer. In this example, each transducer element is comprised of a λ/2-mode multi-stake underwater transducer 414 and a housing 412 which measures about 30^{L}×30^{W}×24H mm³ in dimensions and includes two half-circular cavities 410. This example shows that by incorporating the cavity-baffles in the housing design, a denser array can be realised leading to a higher array gain. The cavities in FIG. 28 can be filled with PU if desired.

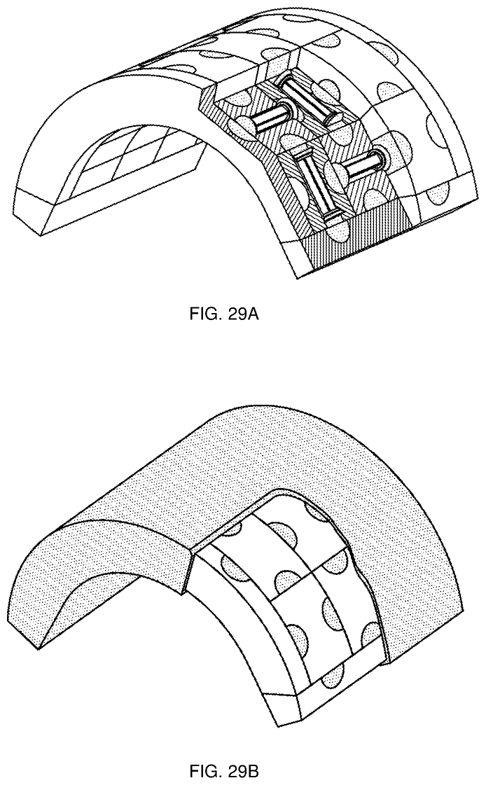

FIG. 29A and 29B depict yet another embodiment of the present invention. The figures show an example of a conforming array of cavity-baffled λ/2-mode multi-stake transducer described in FIG. 28. FIG. 29B depicts the array encapsulated in sound transparent material like PU.

### d₃₁-Mode Multi-Stake Underwater Transducers and Arrays

The above descriptions and acoustic measurement results presented pertain to multi-stake underwater transducers made of [011]-poled d₃₂-mode piezoelectric single crystals of [100] active crystal direction.

For [011]-poled d₃₂-mode single crystals of compositions described in above (e.g. at par. [0082]-[0085]), their axial compressive transformation stresses lie in the range of 10-40 MPa. Thus, under optimum acoustic matching condition (that is, that with near optimum piston-to-crystal area ratios of 4-10 depending on actual single crystal compositions), multi-stake underwater transducers of the present invention made of them will have maximum operating water depths from low hundreds to high hundreds of meters. Beyond these depths, the crystals will undergo a phase transformation and the performance of the transducer will be adversely affected although the crystals and hence the transducer are not damaged.

For improved maximum operating depth, [011]-poled d₃₁-mode lead based relaxor-PT solid solution single crystals of orthogonal [0-11] active crystal direction can be used. Said d₃₁-mode single crystals have much higher axial transformation stresses, being 8× to 15× that of d₃₂-mode single crystals.

The above descriptions also apply to multi-stake underwater transducers made of [011]-poled d₃₁-mode single crystals of compositions described above (e.g.

in par. [0085]) provided that appropriate design changes are made to take care of the higher elastic stiffness and acoustic impedance of d₃₁-mode single crystals, being respectively about 4× and 2× those of d₃₂-mode crystals.

As described above, d₃₁-mode lead based relaxor-PT solid solution single crystals have much higher axial transformation stresses. As a result, appropriately designed multi-stake underwater transducers and arrays made of them are expected to have maximum operating water depths from high hundreds to mid thousands of meters.

### Transmit-Cum-Receive Dual-Mode Transducers and Arrays

While the main objective of the present invention is to disclose the structure and performance of multi-stake underwater transducers and arrays made of transverse-mode piezoelectric single crystals for the generation of underwater sound waves of low-to-mid central frequency, the same transducers and arrays also function as underwater sound wave receivers of high sensitivity over the design frequency range. In other words, they can be used as transmit-cum-receive dual-mode underwater transducers and arrays when so desired.

As illustrated by the various examples provided, since individual multi-stake underwater transducer of the present invention is compact and light, it offers flexibility in design such that compact omni-directional underwater transducers and slim planar, conforming and/or shaped arrays of different configurations and acoustic characteristics can be developed from it to suit various applications.

It will be obvious to a skilled person that the configurations, dimensions, materials of choice of individual multi-stake underwater transducers of the present invention, its derivative transducers and transducer arrays, may be adapted, modified, refined or replaced with a slightly different but equivalent method or design without departing from the principal features of the working principle of our invention, and additional features may be added to enhance the performance and or reliability of the underwater transducer and array. These substitutes, alternatives, modifications, or refinements are to be considered as falling within the scope and letter of the following claims.

What we claim is:

1. A piston-type underwater transducer operating at a central frequency range of 3 kHz to 300 kHz without a pre-stress mechanism, comprising a single crystal motor section, a first head mass, a second head mass, a housing and sound transparent window material,
wherein the motor section is constructed from multiple units of rectangular-shaped [011]-poled d₃₂- or d₃₁-transverse-mode piezoelectric single crystals in a form of a hollow polygonal pipe or spaced parallelly-oriented plates or bonded plates configuration and has an overall load bearing area of less than 40 mm²,
wherein each of the first head mass and the second head mass have a diameter less than 0.4 times the wavelength of sound wave at the operating central frequency in a surrounding medium and wherein each of the first head mass and the second head mass weighs less than 4 grams,
wherein the housing and the sound transparent window material protect the motor section, the first head mass and the second head mass from surrounding medium, and
wherein at least one of the first head mass and the second head mass emits sound wave through the window material into the surrounding medium.

2. The piston-type underwater transducer of claim 1, wherein the piezoelectric single crystals are lead-based relaxor-PT solid solution single crystals comprised of lead zinc niobate-lead titanate (Pb[Zn_{1/3}Nb_{2/3}]O₃—PbTiO₃ or PZN-PT), lead magnesium niobate-lead titanate (Pb[Mg_{1/3}Nb_{2/3}]O₃—PbTiO₃ or PMN-PT), lead magnesium niobate-lead zirconate titanate (Pb[Mg_{1/3}Nb_{2/3}]O₃—Pb[Zr₁₋ₓTiₓ]O₃ or PMN-PZT), lead indium niobate-lead magnesium niobate-lead titanate (Pb[In_{1/2}Nb_{1/2}]O₃—Pb[Mg_{1/3}Nb_{2/3}]O₃—PbTiO₃ or PIN-PMN-PT) or lead indium niobate-lead zinc niobate-lead titanate (Pb[In_{1/2}Nb_{1/2}]O₃—Pb[Zn_{1/3}Nb_{2/3}]O₃—PbTiO₃ or PIN-PZN-PT), including their doped and/or compositionally modified derivatives.

3. The piston-type underwater transducer of claim 1, wherein a ratio of head mass area to overall load bearing area of the piezoelectric single crystals is 3-10.

4. The piston-type underwater transducer of claim 1, wherein an overall crystal load bearing area is less than 25 mm², and
wherein the first head mass and the second head mass has a projecting area 4-8 times the overall load bearing area of the piezoelectric single crystals.

5. The piston-type underwater transducer of claim 1, wherein the first head mass and the second head mass are of equal or substantially equal dimensions and weight, or of different dimensions and weights and
wherein the first head mass and the second head mass emit sound waves into a surrounding medium in λ/2 mode.

6. The piston-type underwater transducer of claim 1, wherein the second head mass is heavier than the first head mass, and
wherein the first head mass emits sound waves into a surrounding medium in λ/4 mode.

7. The piston-type underwater transducer of any of claims 1-6, wherein the first head mass and the second head mass are comprised of one or more of aluminium and aluminium alloys, aluminium-beryllium alloys, aluminium-lithium alloys, magnesium and magnesium alloys, titanium and titanium alloys, including their monolithic alloys with micro-hollow-spheres.

8. The piston-type underwater transducer of any of claims 1-6, wherein the first head mass and the second head mass are comprised of one or more of high specific modulus metal matrix composites, ceramics or fiber-reinforced polymeric matrix composites.

9. The piston-type underwater transducer of any of claims 1-6, wherein the motor section is constructed with an active crystal length shorter than 9 millimeters.

10. The piston-type underwater transducer of any of claims 1-6, wherein the motor section has a two-layer or multi-layer multi-stake structure.

11. The piston-type underwater transducer of any of claims 1-6, wherein the first head mass and the second head mass are of different weights, and
wherein at least one of the first head mass and the second head mass emit sound waves into a surrounding medium.

12. The piston-type underwater transducer of any of claims 1-6, wherein the window material exerts a pull-down force onto at least one of the first head mass and the second head mass.

13. The piston-type underwater transducer of any of claims 1-6, wherein upon assembly the housing exerts a pull-down force via the window material onto at least one of the first head mass and the second head mass.

14. A two-dimensional omni-directional underwater transducer comprising multiple units of the piston-type underwater transducer of any of claims 1-6,
wherein the transducer is configured to provide two dimensional omni-directionality.

15. A three-dimensional omni-directional underwater transducer comprising multiple units of the piston-type underwater transducer of any of claims 1-6,
wherein the transducer is configured to provide three dimensional omni-directionality.

16. An acoustically-tunable λ_{w}/2-sized piston-type underwater transducer comprising multiple units of the piston-type λ/4-mode underwater transducer of any of claims 1-6.

17. A piston-type λ/2-mode underwater transducer of claim 5, further comprising a rigid plain baffle or a cavity baffle.

18. A planar, conforming, or shaped array comprising multiple units of the piston-type underwater transducer of any of claims 1-6 and 17.

19. A planar, conforming, or shaped array comprising at least two units of the piston-type underwater transducer of any of claims 1-6 and 17, per λ_{w}/2×λ_{w}/2 array projecting area,
wherein λ_{w} is the wavelength of sound in water at the central frequency of the operating frequency range of the array.

20. A dual-frequency underwater transducer array comprising multiple units of the piston-type underwater transducer of any of claims 1-6 and 17.

21. A parametric array comprising multiple units of the piston-type underwater transducer of any of claims 1-6 and 17,
wherein the parametric array has a drop-down ratio of less than 10 and is of a single-frequency-band or a dual-frequency-band.

22. A dual-mode underwater transducer of the piston-type underwater transducer of any of claims 1-6 and 17,
wherein the transducer generates and receives sound waves in water.

23. A dual-mode underwater transducer array comprising multiple units of the piston-type underwater transducer of any of claims 1-6 and 17,
wherein the transducer array generates and receives sound waves in water.
